(19) United States
(12) Patent Application Publication
(10) Pub. No.: US 2003/0184552 A1
(43) Pub. Date: Oct. 2, 2003

(54) Apparatus and method for graphics display system for markup languages

(76) Inventor: Sanja Chadha, Nepean (CA)

Correspondence Address: SANJAY CHADHA, 20 KENTSDALE DRIVE, NEPEAN, ON, K2G 6K2, CA

(21) Appl. No.: 10/105,329

(22) Filed: Mar. 26, 2002

(51) Int. Cl. G09G 5/00

(52) U.S. Cl. 345/581

(57) ABSTRACT

Applications such as web-browsers, email clients are currently available on high-end devices such as personal computers, workstations and laptops. The Internet has started to also become available on thin client devices such as touch panel displays, TVs, mobile phones and other handheld devices. The technology currently available for these thin client devices cannot easily utilize the technology from the high-end devices with respect to graphics due to limits on the memory and CPU power available. To overcome this problem, it is necessary to recognize that thin client devices have limited display and display update requirements, and hence, a carefully chosen set of features required by Internet related applications (e.g. browser, email client, instant messaging system) can be implemented in a graphics chip. In particular, a graphics chip can operate in unison with a processing device which sends necessary object information to the graphics chip to display. The processing device fetches the markup language data, parses the markup language data and creates a table of objects. The graphics chip reads the properties of these objects, such as text, image, buttons, text field objects etc., and displays them on the display devices with the use of a number of graphics engines for processing text, image and geometry objects.

This application claims priority from Provisional Application No. 60/277652 entitled “HARDWARE GRAPHICS SUPPORTED SYSTEM TO CREATE ULTRA THIN INTERNET CLIENTS” filed Mar. 27, 2001 by the inventor of the present application.

### FIELD OF THE INVENTION

This invention relates generally to apparatus and methods for graphics display systems and more specifically to apparatus and methods for graphics display system for markup languages.

### BACKGROUND OF THE INVENTION

Computer Graphics technology has made strong progress in relatively high-end machines such as desktops and laptops. Companies such as nVidia, ATI, Genesis, Silicon Video develop graphics chips to drive CRT, LCD displays and Video terminals. These graphics chips support hardware acceleration so that computationally intensive tasks are handled by the hardware freeing up the CPU to do other tasks. Also performing computations in hardware consumes less power than if done in software.

In well-known operating systems (OS) residing on the CPU, knowledge of the pixel data of the displayed information (i.e. the images created on the display) are generated by the OS. All known operating systems for display-based devices (e.g. Personal Computers, Laptops) are aware of the pixel data information. For instance, operating system such as Windows NT, UNIX and Linux generate the information to be displayed. Graphics chips provide support to the OS to off-load the CPU and provide graphics support for primitive objects. The display information generated by operating systems to be displayed is generic (i.e. any shape, form, format, font types, color can be displayed). Because the information displayed on a computer is generic, well-known graphics chip do not have the ability to generate the display data for these devices and hence this has to be done by the OS.

Low-end devices such as ultra thin clients in devices such as TVs, cellular phones, PDAs, pagers have not benefited from the innovations in the field of computer graphics. Low-end thin client devices do not have the processing power or the memory to generate graphics for high-resolution displays.

With the Internet playing a greater role in people's lives and demand for the Internet away from desktop computers increasing, the Internet is going to be ubiquitous. It will become available on all kinds of low-end devices including mobile devices. Displays such as high-resolution displays and micro-displays are expected to play an important role in the new mobile devices. Unfortunately, existing mobile devices (e.g. Cellular phones) do not have the memory or the CPU power to drive these high-resolution displays.

### SUMMARY OF THE INVENTION

Thin clients, which display information fetched from the Internet, have limited display and display update requirements, and hence, a carefully chosen set of features required by Internet related applications (e.g. browser, email client, instant messaging system) can be implemented in a graphics chip. When pages for example are downloaded from the Internet they are displayed from top to bottom. Pages can be scrolled up, down, left or right needing simple graphics capability. In addition requirements to display text, images, simple geometric shapes like buttons, choice buttons, scroll bars can be incorporated into the graphics chip to off load the demands from a processing device, such as a micro-controller or low end CPU.

In embodiments of the present invention, the graphics chip operates in unison with a processing device which sends the necessary object information to the chip to display the information. The processing device fetches markup language data from the Internet or elsewhere, parses the markup language data and creates a table of objects. The graphics chip reads the properties of these objects, such as text, image, buttons, text field objects etc., and displays them on the display devices with the use of a number of graphics engines for processing text, image and geometry objects.

The present invention, according to a first broad aspect, is a method for converting markup language data into display data. This method includes translating the markup language data into object entries within an object table, each object entry comprising a set of properties related to an item for display on a display device; separating the object entries into a plurality of object types; and processing the object entries of each of the object types with separate graphic engines to generate display data corresponding to the object entries.

According to a second broad aspect, the present invention is a graphic display system, arranged to be coupled to a display device. The system includes an interface for receiving markup language data, a markup language processor, a memory device, an object table processor, and a plurality of graphic engines. According to this aspect, the markup language processor operates to translate the received markup language data into object entries, each object entry comprising a set of properties related to an item for display on the display device. The memory device operates to store an object table that stores the object entries. The object table processor operates to separate the object entries into a plurality of object types. Each graphic engine operates to process the object entries of a specific object type to generate display data corresponding to the object entries.

In a third broad aspect, the present invention is a processing apparatus, arranged to be coupled to a graphics engine apparatus including an object table. The processing device includes an interface for receiving markup language data; parsing logic for parsing the received markup language data into one or more markup language tags; and processing logic that operates, for a plurality of the parsed markup language tags, to insert an object entry corresponding to the particular parsed markup language tag into the object table. Each object entry comprises a set of properties related to an item for display on a display device.

The present invention, according to a fourth broad aspect, is a graphics engine apparatus, arranged to be coupled to a processing apparatus and a display device. The graphics engine apparatus includes a memory device, an object table processor and a plurality of graphics engines. The memory device operates to receive object entries from the processing apparatus and store the object entries within an object table, each object entry comprising a set of properties related to an item for display on the display device. The object table processor operates to separate the object entries into a plurality of object types. Each of the graphic engines operate to process the object entries of a specific object type to generate display data corresponding to the object entries.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention are described with reference to the following figures, in which:

FIG. 1 is a simplified block diagram illustrating a typical computer system;

FIG. 2 is a simplified block diagram illustrating a thin client system according to an embodiment of the present invention;

FIG. 3 is a flow chart illustrating the steps for fetching of Markup language files by the micro-controller of FIG. 2;

FIG. 4 is a flow chart illustrating the steps for parsing of Object language and creating of a table representing the objects fetched in Markup files fetched in the process of FIG. 3;

FIG. 5 is a high-level block diagram of a thin client system according to an embodiment of the present invention;

FIG. 6 is a logical block diagram illustrating the functionality of the graphics chip of FIGS. 2 and 5;

FIG. 7 is a logical block diagram illustrating the functionality of the Raw Data Memory of FIG. 6;

FIG. 8 is a logical block diagram illustrating the functionality of the Processed Image Memory of FIG. 6;

FIG. 9 is a logical block diagram illustrating the functionality of the Graphics Engine 1 of FIG. 6 with the Raw Data Memory of FIG. 7;

FIG. 10 is a flow chart illustrating the steps for managing the scrolling of the display;

FIG. 11 is a flow chart illustrating the steps for managing movement of a mouse (cursor) on the display;

FIG. 12 is a flow chart illustrating the steps for managing clicks of a mouse on an object displayed on the display;

FIG. 13 is a flow chart illustrating the steps for managing user interaction with Internet based applications; and

FIG. 14 is an illustration of an example web page, which is displayed over two screens.

### DETAILED DESCRIPTION OF THE PREFERRED EMBODIMENTS

In the following detailed description of embodiments of the present invention, reference is made to the accompanying figures, which form a part hereof, and in which is shown by way of illustration specific embodiments in which the invention may be practiced. It is to be understood that other embodiments may be utilized and structural changes may be made without departing from the scope of the present invention.

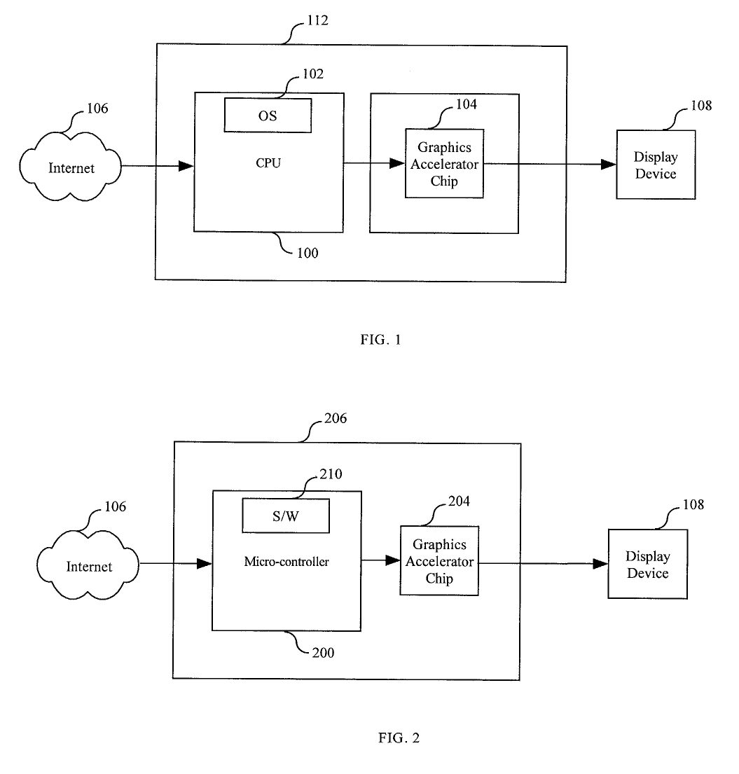

FIG. 1 shows a simplified block diagram of a typical high-end computer system 112 coupled between the Internet 106 and a display device 108. The computer system 112 of FIG. 1 comprises a high-end CPU 100, on which runs an OS 102, and a graphics accelerator chip 104. The OS 102 drives the graphics chip 104 for the applications that run on it and also for information fetched from the Internet 106. The well-known graphics chip 104 provides low level graphics functionality for the display device 108 such as draw line, draw text, BIT BLT (Bit Block Transfer) etc.

FIG. 2 shows a simplified block diagram of a thin client system 206 according to an embodiment of the present invention coupled between the Internet 106 and a display device 108. The system 206 comprises a micro-controller or a low-end CPU 200 and a high-level graphics chip 204 according to an embodiment of the present invention as will be described herein below. The graphics chip 204 according to various embodiments of the present invention provides high-level functionality such as one or more of drawing of text, images, geometry objects and high-level graphic objects such as buttons and scroll bars. Software 210 residing on the micro-controller or the low-end CPU 200 fetches Internet files from the Internet 106, parses the files and sends high-level commands to the graphics chip 204.

In FIG. 1, Internet access and display capability is provided by an application such as a browser which uses the capability of the OS 102 to create the information required to be displayed on the display device 108. The OS 102 is responsible for displaying the text, images and other GUI related components such as button, scroll bar, etc. The graphics chip 104 only provides low level graphics accelerator capabilities. In the system of FIG. 2, according to an embodiment of the present invention, Internet access and display capability is provided by software 210, which parses the markup language files and creates high level commands for the graphics chip 204. The graphics chip 204 processes these commands and displays information on the display device 108. The graphics chip 204 generates the display information for the text, GUI, images and the geometry shapes.

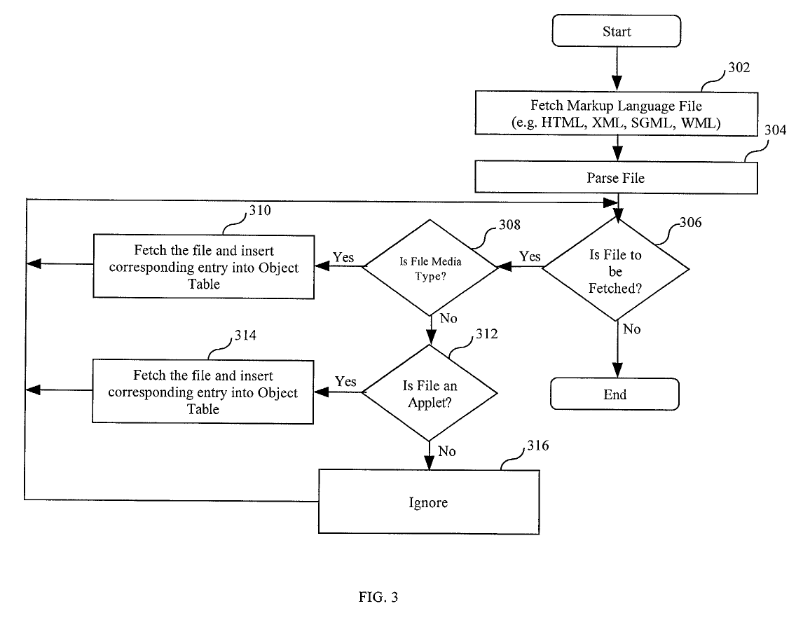

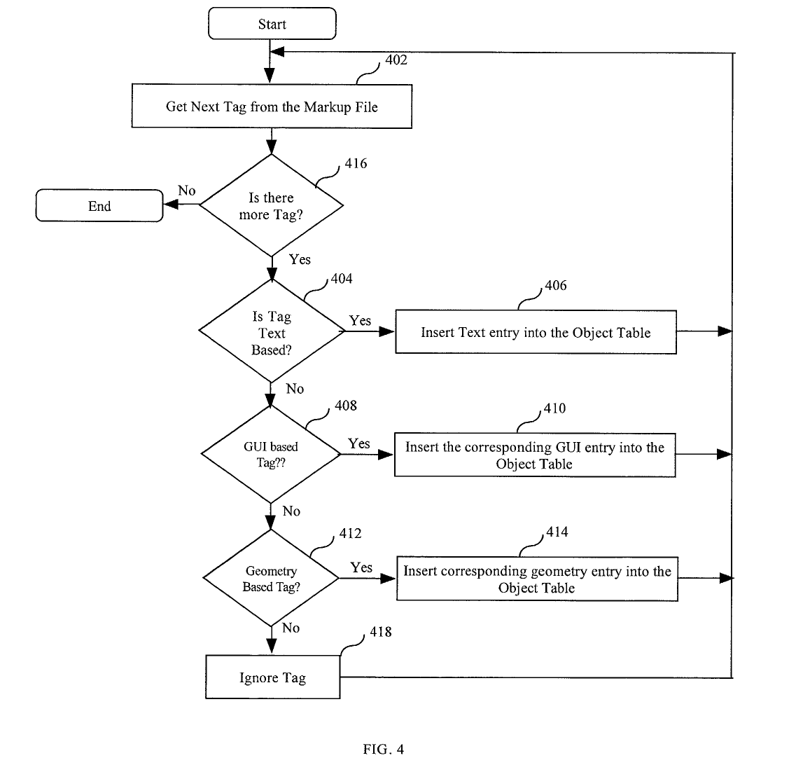

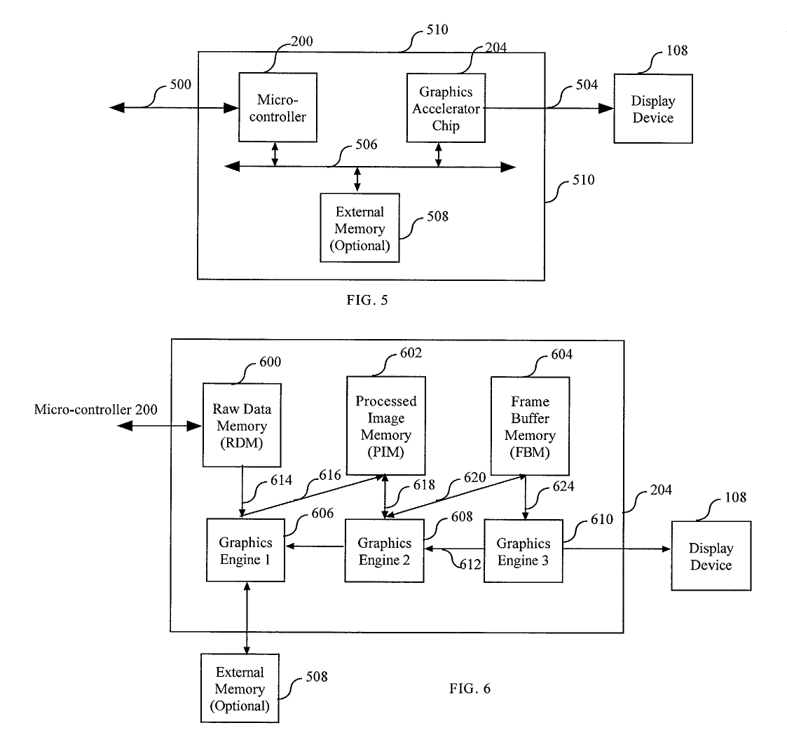

FIG. 3 depicts a flow chart illustrating the steps performed by the software 210 according to an embodiment of the present invention for fetching markup language files (e.g. HTML, SGML, XML, WML) and/or media (e.g. GIF, JPEG) files from the Internet 106 and creating entries in an Object Table within the graphics chip 204 described below with reference to FIGS. 6-9. The process of FIG. 3 starts when a request is sent to the Internet 106 to fetch a markup language file at step 302. The file when received is parsed at step 304 as will be described herein below with reference to FIG. 4. Next, the software 210 determines if there is a file referred to in the fetched markup file that needs to be fetched at step 306. If there is not a file to be fetched at step 306, the software completes the process.

If there is a file that needs to be fetched, a check is made to see if the to-be-fetched file is a media file at step 308. If the to-be-fetched file is a media file, the media file is fetched and a corresponding entry is added in the Object Table at step 310. The process is then returned to step 306 to check if there is another file to be fetched. If at step 308 it is determined that the file is not a media file, a check is made if the to-be-fetched file is a JAVA applet. If the to-be-fetched file is a JAVA applet, a corresponding entry is added in the Object Table at step 314 and the process is returned to step 306 to check for additional files that need to be fetched. If the to-be-fetched file is not a JAVA applet, the embedded file is ignored at step 316 and returned to step 306 to check if there is another file to be fetched.

FIG. 4 depicts a flow chart illustrating the steps performed by the software 210 according to an embodiment of the present invention for the parsing of the received markup file shown at step 304 of FIG. 3. The process starts by parsing the next markup language tag in the markup file at step 402. A check is made to determine if there is a tag left at step 416. If there is a tag left, a check is made to determine if the tag is a text-based tag at step 404. If the tag is a text-based tag, a text entry is added in the Object Table and the process returns to step 402 to get the next tag. If the tag is not a text-based tag, a check is made to determine if the tag is for a Graphical User Interface (GUI) based object at step 408. If it for a GUI-based object, then an entry representing the GUI is added into the Object Table at step 410 and the process returns to 402 to get the next tag. If the tag is not a GUI-based tag, a check is made to determine if the tag is a geometry-based tag 412. If the tag is a geometry-based tag, a corresponding entry is made in the Object Table at step 414 and the process returns to step 402 to check if there is any tag left. If the tag is not a geometry-based tag (and therefore not a text-based, GUI-based or geometry-based tag), the tag is ignored at step 418 and the process is returned to 402 to get the next tag. The process ends when there is no markup language tag left to process.

FIG. 5 depicts a high-level block diagram of an embedded system 510 providing Internet access capability for ultra-thin client systems according to an embodiment of the present invention. Within this system 510, the micro-controller 200 is coupled to an external media 500 such as an Ethernet connection through an RJ/45 port. The graphics chip 204 receives data and commands from the micro-controller 200 via a databus 506 through a memory mapped address space mapped in the micro-controller 200. The graphics chip 204 connects to the external display device 108 through a connector such as a VGA or a Video connector 504. External memory 508 is an optional part of the embedded Internet access system 510. External memory 508 is used to store the media files, which may not fit in the on-chip RAM in the graphics chip 204.

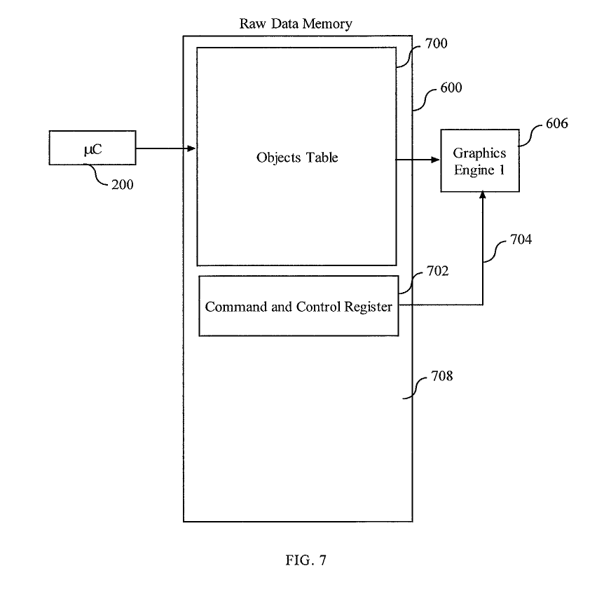

FIG. 6 depicts a logical block diagram of the graphics chip 204 of FIGS. 2 and 5. As depicted, the graphics chip 204 comprises a Raw Data Memory (RDM) 600, Processed Image Memory (PIM) 602, Frame Buffer Memory (FBM) 604 and Graphics Engines 1-3 606,608.610. The RDM 600 is accessible to both the micro-controller 200 and the graphics chip 204 and is used to store the Object Table described herein below with reference to FIG. 7. The PIM 602 contains pixel data display information created from processing the raw data in the RDM 600. Raw data in RDM is processed into final display data ready to be copied into the FBM 604. This multi-buffer scheme is used since there is very little time between two consecutive updates of the frame buffer, called a vertical retrace. The FBM 604 is updated only between two consecutive frame updates to avoid Image tearing.

Graphics Engine 1 (GE1) 606 reads the entries in the Object Table in the RDM 600 via event 614, generates the image display data and outputs this image display data to the processed image buffer of PIM 602 via event 616. PIM 602 may be smaller than the FBM 604. In such a case, GE1 606 would create only a portion of the final image in each run. Thus, it would take R/r such generations to create a complete display screen where R is the number of rows in FBM 604 and r is the number of rows in PIM 602.

Graphics Engine 2 (GE2) 608 copies the image from the PIM 602 via event 618 and copies the image into the FBM 604 via event 620. GE2 608 performs the copying when Graphics Engine 3 (GE3) 610 is between two refresh cycles, which is indicated to GE2 by event 612.

GE3 610 reads the FBM 604 via event 624 and processes the data to be sent to the display 108. This FBM 604 contains data in the pixel display form (i.e. the data to be displayed on the connected display 108). The size of this memory is C×R×B bytes, where C is number of columns in pixels of the display, R is the number of rows in pixels of the display and B is the bytes of data per pixel.

FIG. 7 depicts a logical block diagram illustrating the RDM 600 in relation to the micro-controller 200 and GE1 606. The RDM 600 comprises the Command and Control Register (CCR) 702, which enables the micro-controller 200 to send commands to the chip 204, and the Object Table 700, which contains information about the different objects and object data to be displayed on the page fetched from the Internet 106.

Further, the RDM 600 comprises additional space 708 not used by the Object Table 700 and CCR 702. This additional space 708 is used to store information about the different objects in the Object Table 700. For example, this is the memory space in which text and image data is placed by the micro-controller 200.

In embodiments of the present invention, the CCR 702 supports the following commands:

1. Refresh—Refresh a complete page or a small area of the FBM 604.

2. Move Mouse—Move a mouse to an absolute location or relative to the previous location. X and Y position is provided with this command.

An event 704 is sent to the GE1 606, each time a micro-controller writes a command into CCR 702.

The micro-controller 200 fills the Object Table 700 according to the results of the parsed information received in the web pages. The following information is provided for each object in the Object Table 700:

Location and Size: Each object's upper left hand corner and its width and height is stored in the RDM 600. Objects are arranged in increasing pixel order in the Y direction. This makes it efficient to find the objects within a given area on the display screen. The objects for the complete web page are placed in the RDM 600, and not just the ones, which are currently displayed.

Object Type: Type of the object to be displayed. The following is an example list of object types:

1. Text

2. Image (GIF, JPEG etc.)

3. Choice Button (circle with associated text)—Selected and not selected states.

4. Radio Button (square with associated text)—Selected and not selected states.

5. Scroll bar (Horizontal, Vertical)—This object is displayed by the ASIC without the intervention of the micro-controller 200.

6.Button with associated text (depressed and non depressed states)

7. Text Area (with associated scroll bar and rectangular box).

8. Line (Vertical and Horizontal line)

9. Table

Object Properties: Properties related to each object are stored. Different objects have different properties. For example, text has number of characters, font type and font size as its properties. A button object has number of characters (for the text), state of button (passive, depressed) etc. as the properties.

Data pointer: The data pointer points to the data related to the object i.e. text for the Text object, image data for an Image object. Object data can reside on the on-chip memory or on the optional external memory.

A further important property is “fixed”. This is used to identify objects, which are fixed on the displayed screen and are not moved or scrolled. These objects allow different configurations of the browser. Some objects, which are “fixed”, are scroll bars, menu buttons, status bar and the title bar.

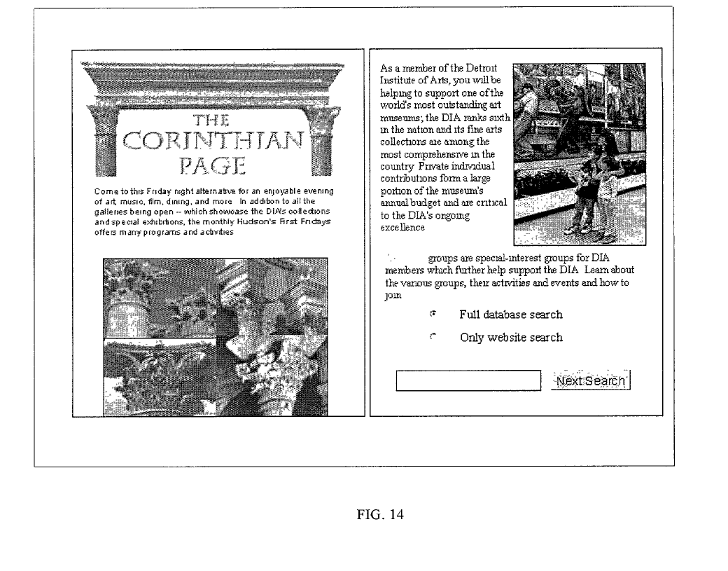

Table 1 shows an example of what will be stored in the RDM Object Table 700 for the 2 screens of a sample web page as shown in FIG. 14.

TABLE 1
Example Object Table 700 in RDM 600

| | Y | X | | | |
|---|---|---|---|---|---|
| Object | Pixel, | Pixel, | Object | | Data |
| Valid | Y Size | X Size | Type | Object Properties | pointer |
| Yes | 10, | 10, | GIF | Size, Image type | Pointer |
| | 250 | 620 | Image | | to |
| | | | | | image |
| Yes | 270, | 10, | Text | Number of characters, | Pointer |
| | 50 | 620 | | Font Type, Font Size, | |
| | | | | Bold/Italic/Underline | |
| Yes | 330, | 301, | GIF | Size, Image type | Pointer |
| | 50 | 300 | Image | | to |
| | | | | | image |
| Yes | 330, | 301, | GIF | Size, Image type | Pointer |
| | 50 | 610 | Image | | to |
| | | | | | image |
| Yes | 380, | 30, | GIF | Size, Image type | Pointer |
| | 50 | 300 | Image | | to |
| | | | | | image |
| Yes | 380, | 301, | GIF | Size, Image type | Pointer |
| | 50 | 610 | Image | | to |
| | | | | | image |
| Yes | 510, | 10, | Text | Number of characters, | Pointer |
| | 280 | 300 | | font, size | to text |
| Yes | 510, | 301, | GIF | Size, Image type | Pointer |
| | 290 | 600 | Image | | to |
| Yes | 810, | 10, | Text | Number of characters, | Pointer |
| | 30 | 610 | | font, size | to text |
| Yes | 850, | 60, | Choice | Number of characters, | Pointer |
| | 10 | 400 | Button | Selected | to text |
| Yes | 865, | 60, | Choice | Number of characters | Pointer |
| | 10 | 400 | Button | | to text |
| Yes | 880, | 30, | Text | | |
| | 20 | 500 | Field | | |
| Yes | 880, | 550, | Button | Number of characters | Pointer |
| | 20 | 60 | | | to text |

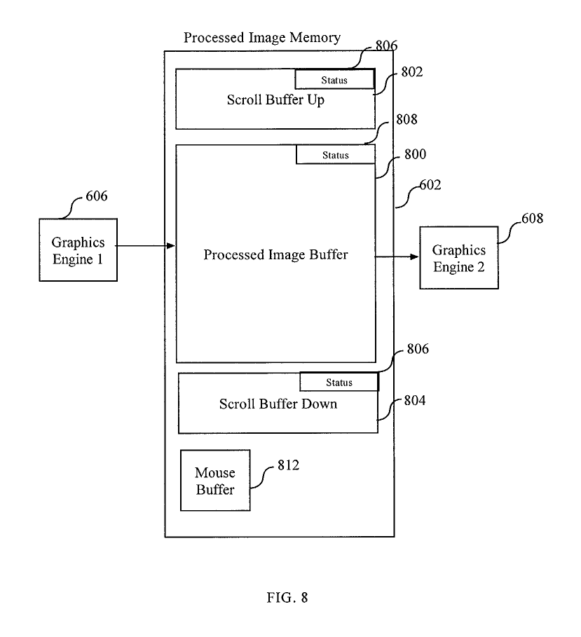

FIG. 8 is a logical block diagram illustrating PIM 602, according to an embodiment of the present invention, in relation to GE1 and GE2 608. The PIM 602 comprises pixel data display information created from processing the raw data in RDM 600. Raw data in RDM 600 is processed into final information ready to be copied into FBM 604. PIM 602 comprises four logical sections, Processed Image Buffer (PIB) 800, Scroll Buffer (SB) Up 802, SB Down 804 and Mouse Buffer (MS) 812.

The PIB 800 comprises the processed pixel image which has to be displayed on the display. This memory may have the same size as that of the FBM 604; however since the size of the FBM is potentially large (640×480×2×8 bits for 16 bit color VGA and 800×600×2×8bits for 16 bit color SVGA) keeping a complete copy of the buffer will need larger memory. PIB 800 contains the image, which the GE2 608 copies to the FBM 604.

SB Up, SB Down 802,804 contain the pixel data of the image, which is to be displayed when the web page is scrolled in the up and down directions respectively.

MB 812 is used to store pixel data covered by the cursor on the screen. As the mouse moves around on the screen, the cursor covers and uncovers parts of an image. The MB 812 keeps the covered part of the display so that it can be copied back when the mouse moves to a new location.

Each buffer in the PIM 602 is associated with “status” information 806,808,810 that indicates that the information in the corresponding memory is ready for the display.

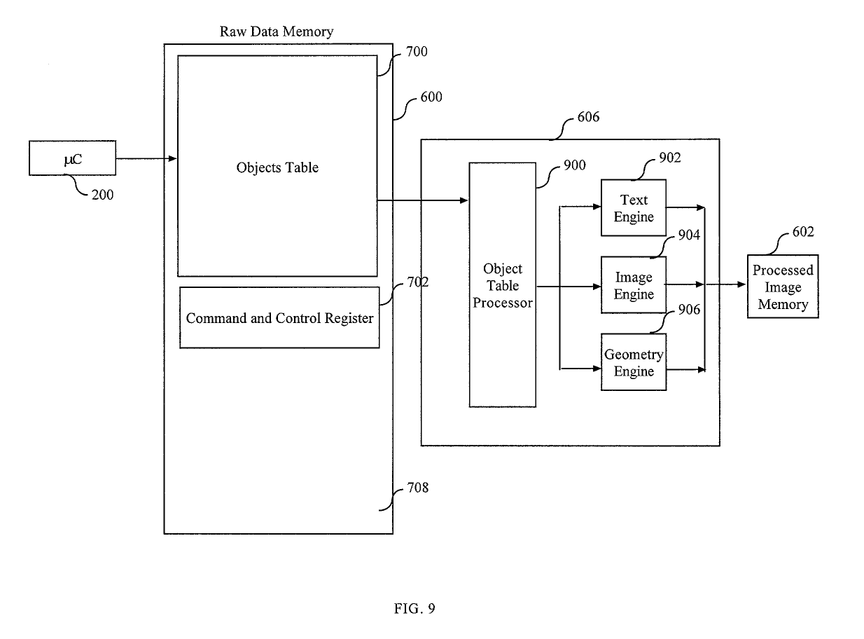

FIG. 9 is a logical block diagram illustrating the GE1 606 and its relation with RDM 600 and PIM 602. As depicted, GE1 606 comprises Object Table Processor 900, Text Engine 902, Image Engine 904 and Geometry Engine 906. The Object Table Processor 900 reads each entry in the Object table 700 and forwards the object to be processed to the corresponding engine depending on the kind of object. Text related objects are passed to the Text Engine 902, which takes the text and generates pixel data for the text in proper font type and font size. Image objects are passed to the Image Engine 904, which reads the image for example in JPEG or GIF, format and generates the necessary pixels for the image. Geometry objects such as line, box, button etc are passed to the Geometry Engine 906, which draws the objects, such as lines, boxes and buttons. Outputs from each of the engines are stored within the PIB 800 of the PIM 602.

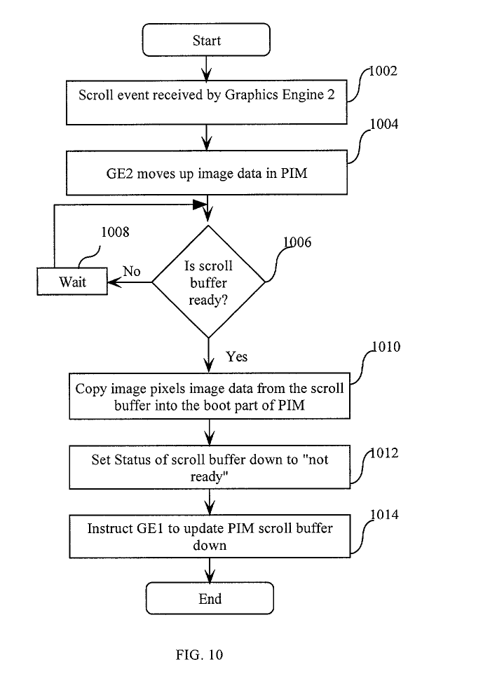

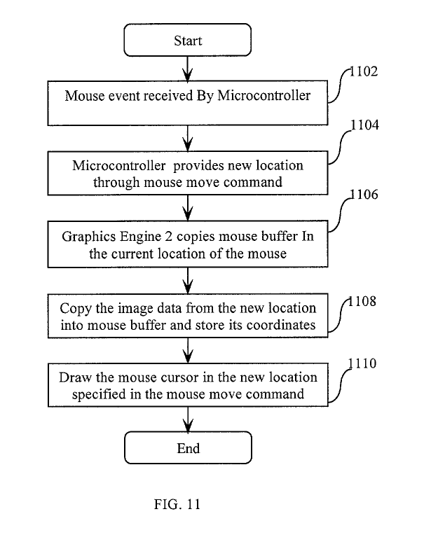

FIG. 10 is a flow chart illustrating the steps performed for managing the scrolling of the display 108. The process is outlined for scrolling down of the display, though it should be noted that a similar process is used to scroll left, right and up for the display 108. The process starts when a scroll event is received by GE2 608 at step 1002. The scroll event is generated by a mouse or an equivalent device outside the micro-controller 200 and graphics chip 204. GE2 608 then does a block move of display data in PIB 800 at step 1004. The size of the move depends on the size of the SBs 802,804. The size of the move is the difference in size of the PIB 800 and SBs 802,804. A check is made to determine if SB Down's 804 status 810 is ready at step 1006. If the status is not ready, GE2 608 waits at step 1008 until the status is ready. If the SB Down is ready, GE2 608 copies the image data from the SB Down 804 into the bottom portion of PIB 800 at step 1010. GE2 608 then sets the status of the SB Down 804 to “not ready” at step 1012 and instructs GE1 606 to update the SB Down 804 at step 1014 to end the process of scrolling. The next frame refresh by GE3 610 would read the updated data in the PIB.

FIG. 11 is a flow chart illustrating the steps performed according to an embodiment of the present invention for managing the movement of the mouse on the display 108. The process starts when a mouse move event is received by the micro-controller 200 at step 1102. The micro-controller 200 provides the new location to the graphics chip through a mouse move command at step 1104. Subsequently, the GE2 608 copies the contents of MB 812 into the current location of the mouse pointer in the FBM 604 at step 1106 and copies the image data from the new location of the mouse from the FBM 604 into the MB 812 with its associated coordinates at step 1108. It then draws the mouse cursor in FBM 604 in the new location of the mouse pointer at step 1110.

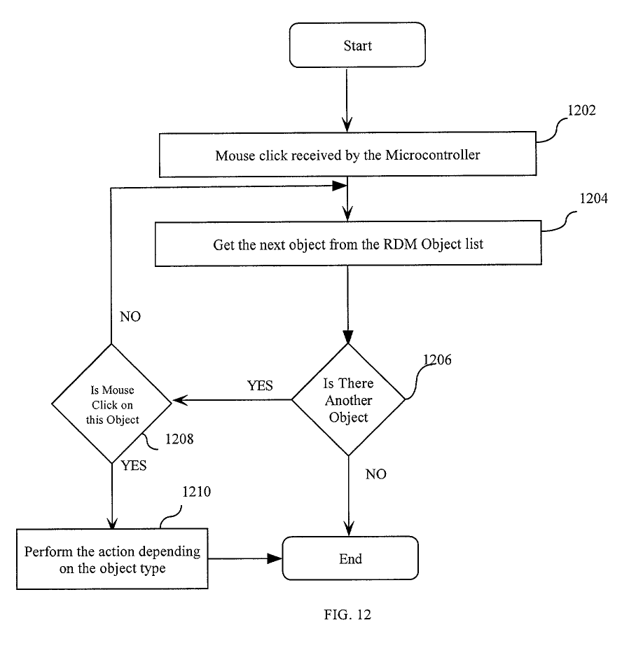

FIG. 12 is a flow chart illustrating the steps performed for managing mouse click events by the software 210 on micro-controller 200. The process starts when micro-controller 200 receives a mouse click event. The micro-controller 200 at all times remembers the current position of the mouse and a list of the objects which are affected by the click of a mouse. Subsequently, the micro-controller 200 retrieves the next object from the list of objects which are affected by a mouse click at step 1204 and checks to see if there is any object left within the list at step 1206. If there is another object left, the micro-controller 200 checks if the mouse click is on the object at step 1208. The following is used to find out if the mouse click occurred on the object.

X, Y coordinates of where the mouse is clicked,

Top of the current displayed page

Location of all the objects in the web page.

If the mouse is on this object, the micro-controller 200 triggers the performing of the action depending on the object type at step 1210. If the mouse is not on this object, the process returns to step 1204 to get another object from the list of objects. The process ends when there are no more objects or if it is determined that the mouse is on a particular object.

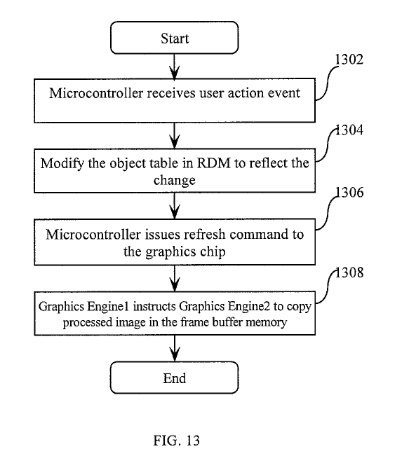

FIG. 13 is a flow chart illustrating the steps for managing user actions, such as entering text into a text field or selection/deselection of an icon choice button. The process starts when the micro-controller 200 receives an event at step 1302. When the text is entered into a text field or a choice button is selected, the micro-controller 200 modifies the Object Table 700 in the RDM 600 at step 1304. The micro-controller 200 issues a “Refresh” command at step 1306 which instructs GE1 606 to re-process the image for a given rectangular region. GE1 606 then instructs GE2 608 to copy the processed image into the appropriate section in the FBM 604 at step 1308 and the process is terminated.

Although the above described embodiments were specific to graphic support systems coupled to the Internet, it should be noted that in alternative embodiments, the Internet could be any network or local environment which has access to markup language files with one or more of text, image and geometry objects. For instance, the markup language files could be accessed from a non-network source such as a local memory device.

Although the above description depicts a graphics support system in which micro-controller 200 and graphics chip 204 are separate entities locally coupled together, this should not limit the scope of the present invention. In one alternative embodiment of the present invention, the functionality of the two devices 200,204 are integrated together on a single semiconductor device. In another alternative embodiment, the graphics engine capability of the graphics chip 204 resides on the micro-controller 200 through an implementation within software. In this embodiment, an external graphics chip such as device 104 of FIG. 1 may be required. In yet a further alternative embodiment, the micro-controller 200 or the software 210 and the graphics chip 204 or equivalent devices may be integrated within different systems separated by a network.

Although the above descriptions of the present invention specify the use of a micro-controller, it should be recognized that other processing devices could be utilized such as a CPU or a Digital Signal Processor (DSP).

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

I claim:

1. A method for converting markup language data into display data comprising:
translating the markup language data into object entries within an object table, each object entry comprising a set of properties related to an item for display on a display device;
separating the object entries into a plurality of object types; and
processing the object entries of each of the object types with separate graphic engines to generate display data corresponding to the object entries.

2. A method according to claim 1, wherein the translating the markup language data into object entries within an object table comprises parsing the markup language data into one or more markup language tags and, for a plurality of the parsed markup language tags, inserting a set of properties related to an item for display corresponding to the particular parsed markup language tag into the object table.

3. A method according to claim 1, wherein the set of properties related to an item for display comprises the location, size and type of the item for display.

4. A method according to claim 3, wherein the set of properties related to an item for display further comprises at least one of type specific properties and a data pointer.

5. A method according to claim 1, wherein the plurality of object types comprises text, image and geometry types; and
wherein the processing the object entries of each of the object types comprises processing object entries of the text type with a text graphic engine, processing object entries of the image type with an image graphic engine and processing object entries of the geometry type with a geometry graphic engine.

6. A graphic display system, arranged to be coupled to a display device, comprising:
an interface for receiving markup language data;
a markup language processor, coupled to the interface, for translating the received markup language data into object entries, each object entry comprising a set of properties related to an item for display on the display device;
a memory device, coupled to the markup language processor, for storing an object table that stores the object entries;
an object table processor, coupled to the memory device, for separating the object entries into a plurality of object types; and
a plurality of graphic engines, each coupled to the object table processor, each graphic engine for processing the object entries of a specific object type to generate display data corresponding to the object entries.

7. A graphic display system according to claim 6, wherein the markup language processor in order to translate the received markup language data operates to parse the markup language data into one or more markup language tags and, for a plurality of the parsed markup language tags, insert a set of properties related to an item for display corresponding to the particular parsed markup language tag into the object table.

8. A graphic display system according to claim 6, wherein the plurality of object types comprises text, image and geometry types; and
wherein the plurality of graphic engines comprises a text graphic engine for processing object entries of the text type, an image graphic engine for processing object entries of the image type and a geometry graphic engine for processing object entries of the geometry type.

9. A graphic display system according to claim 6, wherein the markup language processor operates without the use of a standard operating system.

10. A graphics display system according to claim 6, wherein the interface and markup language processor are integrated together within a first apparatus and the memory device, object table processor and plurality of graphics engines are integrated within a second apparatus coupled to the first apparatus.

11. A graphics display system according to claim 10, wherein the first and second apparatus are physically adjacent to each other.

12. A graphics display system according to claim 10, wherein the first and second apparatus are coupled together via a network.

13. A graphics display system according to claim 6, wherein the interface, markup language processor, memory device, object table processor and plurality of graphics engines are integrated within a single apparatus.

14. A graphics display system according to claim 13, wherein the single apparatus is a processing device capable of running software algorithms; and
wherein the markup language processor, object table processor and plurality of graphics engines are implemented within software algorithms.

15. A display component incorporating the graphic display system according to claim 6 and further comprising:
a display device for receiving the display data corresponding to the object entries and depicting graphically the properties of the object entries.

16. A processing apparatus, arranged to be coupled to a graphics engine apparatus including an object table, the processing device comprising:
an interface for receiving markup language data;
parsing logic for parsing the received markup language data into one or more markup language tags; and
processing logic that operates, for a plurality of the parsed markup language tags, to insert an object entry corresponding to the particular parsed markup language tag into the object table, each object entry comprising a set of properties related to an item for display on a display device.

17. A processing apparatus according to claim 16, wherein the set of properties related to an item for display comprises the location, size and type of the item for display.

18. A processing apparatus according to claim 17, wherein the type of the item comprises one of text, image and geometry types.

19. A processing apparatus according to claim 16, wherein the processing apparatus operates without the use of a standard operating system.

20. A graphics engine apparatus, arranged to be coupled to a processing apparatus and a display device, the graphics engine apparatus comprising:
a memory device, coupled to the processing apparatus, for receiving object entries from the processing apparatus and storing the object entries within an object table, each object entry comprising a set of properties related to an item for display on the display device;
an object table processor, coupled to the memory device, for separating the object entries into a plurality of object types; and
a plurality of graphic engines, each coupled to the object table processor, each graphic engine for processing the object entries of a specific object type to generate display data corresponding to the object entries.

21. A graphics engine apparatus according to claim 20, wherein the plurality of object types comprises text, image and geometry types; and
wherein the plurality of graphic engines comprises a text graphic engine for processing object entries of the text type, an image graphic engine for processing object entries of the image type and a geometry graphic engine for processing object entries of the geometry type.

22. A graphics engine apparatus according to claim 20, wherein the set of properties related to an item for display comprises the location, size and type of the item for display.

23. An apparatus for converting markup language data into display data comprising:
means for translating the markup language data into object entries within an object table, each object entry comprising a set of properties related to an item for display on a display device;
means for separating the object entries into a plurality of object types; and
means processing the object entries of each of the object types with separate graphic engines to generate display data corresponding to the object entries.
